(19) United States
(12) Patent Application Publication
(10) Pub. No.: US 2025/0249595 A1
(43) Pub. Date: Aug. 7, 2025

(54) MACHINE HANDLING OF NON-RIGID MATERIALS

(71) Applicant: Sufficiently Advanced, Inc., San Francisco, CA (US)

(72) Inventors: Peter Clement LI, Belmont, CA (US); Akshay Kashyap, San Francisco, CA (US)

(21) Appl. No.: 19/042,470

(22) Filed: Jan. 31, 2025

Related U.S. Application Data
(60) Provisional application No. 63/549,032, filed on Feb. 2, 2024.

(51) Int. Cl. B25J 9/16

(52) U.S. Cl. CPC B25J 9/1697; B25J 9/163; B25J 9/1682

(57) ABSTRACT

Systems and methods that train, generate, and/or deploy generative machine learning (ML) models to control operations of machines, such as machines that employ robotic arms to manipulate non-rigid materials, are described. For example, the systems and methods may generate the generative ML models based on initial or introductory demonstrations of tasks for which the machines are adapted and/or implemented and deploy the trained ML models to the machines for performance of the tasks.

### CROSS-REFERENCE TO RELATED APPLICATIONS

This application claims priority to U.S. Provisional Patent Application No. 63/549,032, filed on Feb. 2, 2024, entitled A METHOD TO PROGRAM MACHINES TO MANIPULATE NON-RIGID MATERIALS FROM DEMONSTRATIONS, which is hereby incorporated by reference in its entirety.

### BACKGROUND

Generative artificial intelligence (AI) and/or machine learning (ML) involves the use of ML models to produce, or generate, certain forms of new data from underlying training data. For example, a generative AI or ML model may be trained on and/or utilized to create or generate text, images, video, and so on. Such AI or ML models may employ neural networks, such as deep neural networks. Examples include generative pre-trained transformers (GPTs), which are used in many industries, including healthcare, finance, entertainment, manufacturing, and others.

### BRIEF DESCRIPTION OF THE DRAWINGS

Embodiments of the present technology will be described and explained through the use of the accompanying drawings.

FIG. 1 is a block diagram illustrating a suitable network environment.

FIG. 2A is a block diagram illustrating components of a machine control system.

FIG. 2B is a block diagram illustrating a demonstration of a task to be performed by a machine.

FIG. 3 is a diagram illustrating a network architecture for implementing a machine learning generative model that controls material handling machines.

FIG. 4 is a flow diagram illustrating operations performed by the machine control system.

FIG. 5 is a flow diagram illustrating a method for controlling a material handling machine.

FIG. 6 is a flow diagram illustrating a method for sorting non-rigid materials using a machine controlled by a machine learning model.

FIGS. 7A-7C are diagrams depicting the operation of a machine sorting non-rigid materials.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

The manipulation of non-rigid materials (e.g., cloth or fabrics) has been a long-standing problem in industry. Often, automated solutions rely on explicit programming for predictable object handling, such as moving boxes, welding automotive parts, and applying gaskets. However, these automated solutions, which utilize the explicit programming of specific tasks, are not useful for tasks using non-rigid materials, such as fabric or clothing. For example, a non-rigid material may have a high degree of freedom, leading to complex interactions and/or self-occlusions when using current automated and/or robotic machines, among other drawbacks.

Various systems and methods enhance the performance, control, and/or operations of machines, such as machines designed to manipulate or handle non-rigid materials, are described. For example, a machine having one or more robotic arms may be controlled by a generative ML model, where the generative ML model is generated and/or trained based on data captured during demonstrations of tasks to be performed by the machine. Example tasks include the manipulation and/or handling (e.g., sorting, folding) of non-rigid materials, rigid materials, and so on.

For example, images (e.g., a stream, set, or group of images) are captured of the demonstration of a task, such as the folding of a sheet in a laundry facility. A machine, controlled by a human (directly or via controls) performs the task of folding the sheet using two robotic arms. Data associated with the machine (e.g., robotic data or movement data) is also captured during the demonstration of the task. After optionally cleaning and processing the data, the image data and the movement data are provided to a generative ML model.

The generative ML model is deployed to a machine, which performs the task using control instructions provided by the generative ML model. The machine may utilize additional inputs and/or feedback to refine its operations while performing the task. Examples include the presence of humans in the vicinity of the machine, voice commands to stop/start operations of the machine, and so on. Thus, the machine may control its operations (e.g., the movement of its robotic arms) based on (e.g., only from) instructions provided by the generative ML model.

The systems and methods described herein, therefore, utilize ML models to control operations of machines, such as machines that employ robotic arms to manipulate non-rigid materials, based on initial or introductory demonstrations of the tasks for which the machines are adapted and/or implemented.

For example, a laundry facility may employ many machines, as described herein, to handle certain tasks, such as the sorting of non-rigid materials (e.g., napkins, sheets, blankets, other fabrics, and so on), the folding of non-rigid materials, the collecting of non-rigid materials, and so on. Using the systems and methods described herein, the machines may also perform tasks related to other materials, such as rigid materials (e.g., forks or other hard objects), combinations of rigid/non-rigid materials, and so on.

As described herein, a rigid material/object may be a material/object that is not flexible and/or unable to bend or be forced out of a shape. Thus, a non-rigid material/object may be a material or object that is flexible, bendable (e.g., foldable), or otherwise deformable based on an applied force. For example, a cloth or fabric napkin or sheet would be a non-rigid material, as the material is foldable and deformable (e.g., the material changes shape when grabbed or gripped by a robotic arm during a sorting or folding operation).

In addition to being implemented with respect to a laundry facility, the systems and methods described herein may be deployed in other environments, locations, or industries. Example use cases include apparel manufacturing and handling, laundry facilities, general manufacturing, construction, and so on. For example, the systems and methods can enable a precise control and handling of non-rigid materials, which can enhance or optimize various tasks, including the tasks of placing clothing on hangers, packing items, stacking and/or unstacking objects, sorting or singulating fabrics, feeding items into a machine, adjusting stacks, and/or otherwise moving or handling objects within or between locations during manufacturing.

In addition to fabrics, other non-rigid materials may include car bumpers, plastics, leather, nylons, hybrid materials, liquids, fluids, films, and so on. For example, the systems and methods may be utilized by machines/robots of different form factors, such as large-scale form factors (e.g., laundry or auto manufacturing) and small-scale form factors (e.g., the handling of cultures within a lab environment). Thus, the systems and methods described herein may enable deployment of ML model instructed machines/robots across various industries, enhancing the efficiency and efficacy of many different tasks within these industries, among other benefits.

Various embodiments of the systems and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Computing Environment

The technology described herein is directed, in some embodiments, to controlling and/or operating the robotic arms of a machine based solely on control instructions generated by an ML model, such as a generative ML model trained using data collected during demonstrations of tasks performed by similar machines (e.g., human controlled or human operated).

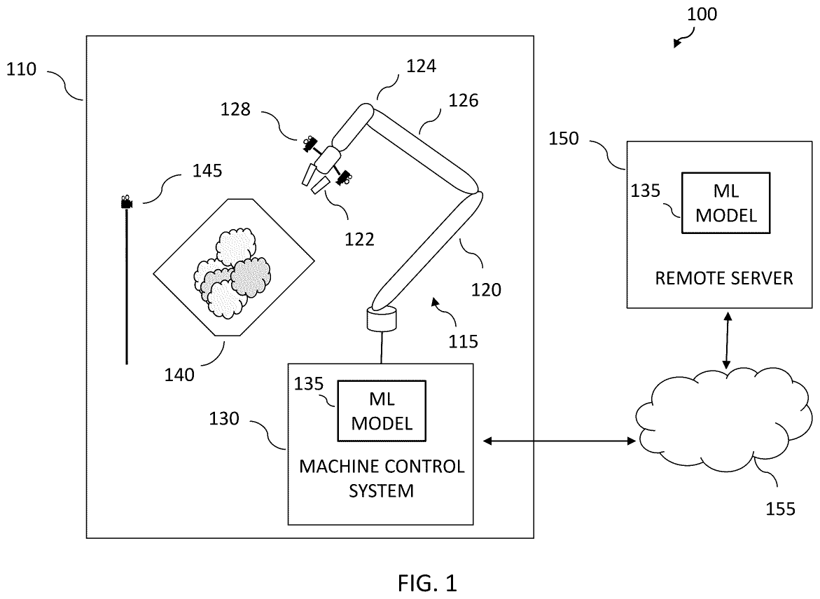

FIG. 1 is a block diagram illustrating a suitable network environment 100. The network environment 100 includes a workstation or area 110, where a machine 115 (e.g., a machine with a robotic arm 120 and/or a robot) is performing a task of sorting a pile 140 of non-rigid materials (e.g., cloth napkins). While shown with one robotic arm 120, the machine 115 may include two or more robotic arms and/or other components that facilitate manipulation of non-rigid materials.

The machine 115 is associated with and/or controlled by a machine control system 130, which includes a deployed generative ML model 135, as described herein. In some cases, the machine control system 130 and/or the machine 115 communicates, over a network 155, with a remote server 150, which can support some or all aspects or modules of the generative ML model 135. For example, the remote server 150 may be in communication with multiple machines at one location or any many different locations and may interact with the different machines over the network 155.

The robotic arm 120 of the machine 115 may include certain features or components, such as an articulated arm 126 that includes one or more joints 124 that separate different pieces of the articulated arm 126. The robotic arm 120 may also include a manipulator 122, which can include various types of manipulation interfaces or devices, such as two-finger grippers, three-finger grippers, vacuum grippers, tweezers, and/or other devices configured to grab, drop, move, handle, or otherwise interact with or manipulate the non-rigid materials in the pile 140. As described herein, the machine may include multiple robotic arms (e.g., the robotic arm 120), such as two arms, three arms, four arms, and so on.

The robotic arm 120 may include or be associated with various sensors, such as image sensors 128 or cameras that capture images of the pile 140 of non-rigid materials (e.g., images of what is in front of the manipulator 122 or what objects/materials the manipulator 122 is handling), an image sensor 145 or camera that captures images of the entire movement of the robotic arm 120 and/or the performance of the task in the workstation 110, and/or other image sensors or cameras. In some cases, settings or parameters (e.g., exposure settings, gain, white balance, and so on) of the image sensor 145 and/or the other images sensors or cameras may be calibrated for the specific capture environment and/or task to be captured.

In some cases, the robotic arm 120 includes one or more depth sensors, such as time-of-flight (ToF) sensors (e.g., LiDAR), near infrared (NIR) sensors, and so on. The depth sensors may include sensors that capture or map the non-rigid materials as three-dimensional (3D) objects, sensors that capture distances between the manipulator 122 and the non-rigid materials, and so on.

The robotic arm 120 may also include inertial measurement units (IMUs) or other sensors that track a position, velocity, and/or acceleration of the robotic arm 120 and/or its various components (e.g., one joint or joint angle relative to another joint or joint angle). Thus, the IMUs may capture data that tracks the movement, translational and/or rotational) of the robotic arm 120 and/or the manipulator 122 in 3D space during performance of a task.

Further, other sensors associated with the workstation 110 may capture data associated with the environment within which a task is performed and/or data associated with the non-rigid materials. For example, the sensors may capture data associated with a weight of the non-rigid materials, a temperature and/or humidity within the workstation 110, and so on. The machine control system 130, as described herein, may utilize the sensor data from any of the sensors when training and/or generating the generative ML model 135.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 155 can be any network, ranging from a wired or wireless local area network (LAN) to a wired or wireless wide area network (WAN), to the Internet or some other public or private network, to a cellular (e.g., 4G, LTE, 5G, or 6G network), and so on. While the connections between the various devices and the network 155 are shown as separate connections, these connections can be any kind of local, wide area, wired, or wireless network, public or private.

Further, any or all components depicted in the Figures described herein can be supported and/or implemented via one or more computing systems, servers, or cloud-based systems. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer, display device, machine or robot, or mobile or portable device, and thus, while certain hardware platforms are described herein, aspects of the system are equally applicable to nodes on a network. In some cases, the mobile device or portable device may represent the server portion, while the server may represent the client portion.

### Examples of Manipulating Non-Rigid Materials Using a Machine

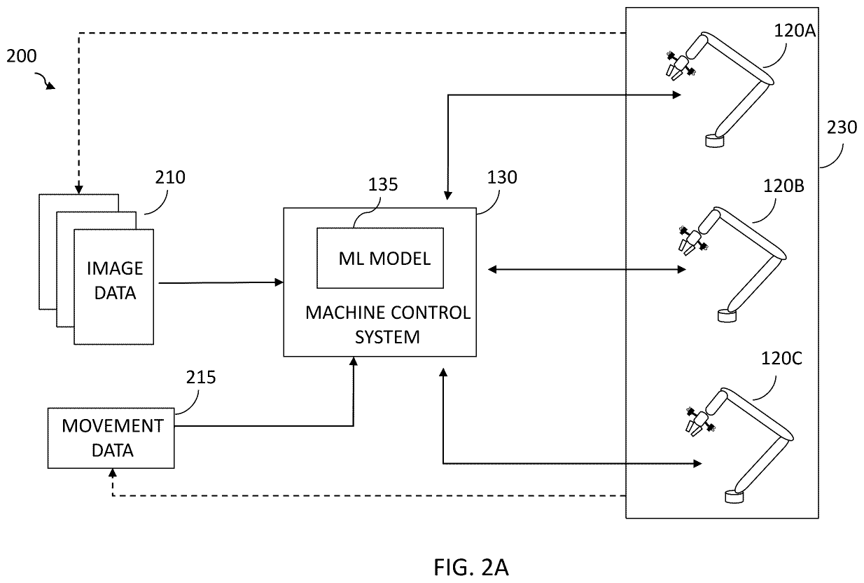

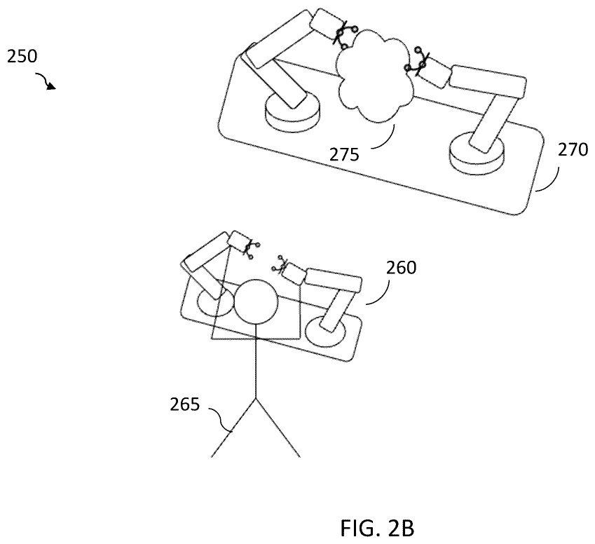

As described herein, in some embodiments, a machine is instructed by a generative ML model to perform certain operations, such as task or other operations associated with the machine control system 130. FIG. 2A is a block diagram 200 illustrating the machine control system 130.

The machine control system 130 may implement a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein.

In some embodiments, the machine control system 130 includes a data collection module that access and/or captures data associated with a demonstration of a task to be performed by a machine having one or more robotic arms, a model generation module that trains an ML model (e.g., the generative ML model 135) based on the captured data, and a machine control module that controls operation of the machine using the ML model.

For example, the machine control system 130, via the data collection module, may access and/or capture image data 210, such as image data associated with a demonstration of a task to be performed by a machine, such as the machine 120. FIG. 2B is a block diagram illustrating a demonstration 250 of a task to be performed by a machine.

As shown, a leader console 260 (e.g., a machine with a robotic arm controlled by a human 265) performs a task, which is followed by a follower console or station 270. The leader module 260 demonstrates a series of tasks, movements, or trials for a particular manipulation of a non-rigid material. The leader console 260 may be a mirror copy of the follower console 270, which is manipulating a non-rigid material 275. In some cases, the leader console 260 may not include a machine (and instead be a human performing the task without a machine). In some cases, the leader console 260 and the follower console 270 may be at the same location. In other cases, the consoles may be remotely located from one another (e.g., communicating over video), where one or both of the consoles are operated by a remote operator. In some cases, a leader console 260 may perform a task for multiple follower consoles 270.

The human 265 may control the leader console 260 by directly handing the robotic arms of the machine. For example, the human may perform different movements by directly manipulating the robotic arms in 3D space. Example movements include pinching or grasping the non-rigid material using a manipulator or other device, moving the robotic arm linearly, rotating the robotic arm, tracing paths in 3D space, shaking materials grasped by the robotic arm, and so on. In some cases, the machine may be controlled via remote control, such as via a game controller, 3D mouse, joystick, AR/VR console, and so on.

The image data 210 may be captured via one or more image sensors (e.g., the image sensor 145) such as RGB cameras that take images (e.g., visible light images) of the leader console 260 during the demonstration of the task. Example images include images of the robotic arm at different times during performance of the task, images of the robotic arm with respect to the non-rigid material, movement of the non-rigid material, and so on.

In some cases, the image data 210 includes or is associated with other types of data, such as weight or humidity data for the non-rigid material and depth data associated with the 3D profile of the non-rigid material. For example, the machine control system 130 may generate a depth map of the non-rigid material, which can complement and/or be associated with the image data 210. In some cases, the image data 210 may include or be associated with ultrasound images of the non-rigid materials.

As described herein, when the human 265 demonstrates the task without a machine, the image data 210 may include images/video (e.g., RGB and/or depth data) that capture movement of the non-rigid material in the 3D space. For example, system 130 may capture the movement of the non-rigid materials and/or of the human manipulating the material and map the captured actions to robotic actions.

The machine control system 130 may also access and/or capture movement data 215 (e.g., robotic data) associated with movement of the machine (e.g., the robotic arm 120 of the machine 115) during the demonstration of the task. The movement data 215 may include data that tracks and/or captures movement (e.g., position and/or angle) of the joints 124 of the robotic arm 120, movement and/or operation of the manipulator 122 of the robotic arm 120, and so on.

In some cases, manipulator data may include movement of the manipulator 122 in 3D space, such as data that indicates the opening and/or closing of the manipulator 122, the gripping or clamping force used when gripping the non-rigid material, a distance between fingers when gripping or holding the non-rigid material, the pose or orientation of the manipulator 122 when performing the task (e.g., or sequence of poses), and so on.

In some embodiments, the movement data 215 may only include data associated with the manipulator 122, such as position data (e.g., end effector (EEF) position quaternions), velocity data (e.g., end effector velocity quaternions), and/or acceleration data (e.g., end effector acceleration quaternions). The machine control system 130 may determine (e.g., via inverse kinematics), using the manipulator data, joint positions for the robotic arm 120. The movement data 215, therefore, may be captured using any haptic and contact-rich datasets and/or measured using dedicated haptic sensors, torque or current readings, and/or estimated through vision data streams or other images (e.g., translating human motion data into the movement data 215).

As described herein, the machine control system 130 may store and/or access the captured data locally (e.g., within a database local to the machine control system 130 and/or the machine 115) and/or remotely (e.g., at the remote server 150). Using the captured data (e.g., the image data 210, the movement data 215, and/or other captured data), the machine control system 130, via the model generation module, trains the generative ML model 135.

In some embodiments, before training the generative ML model 135, the machine control system 130 may clean the captured data. For example, data may be captured during a demonstration when tasks are incorrectly performed, performed too slowly, performed inefficiently, and so on. Thus, the machine control system 130 may prune accessed data sets to remove data captured during tasks, trails, and/or aspects of the demonstration that are undesirable or not useful when training the generative ML model 135.

When training the generative ML model 135, the machine control system 130 may consider the image data 210 as input data and the movement data 215 as output data. The system 130 feeds both data sets into a generative model, such as a diffusion model, an adversarial generative model, and/or models that employ variational encoders and/or transformers. The generative model may compute internal parameters (e.g., weights), which map the inputs to the outputs while minimizing differences (e.g., loss) between an output generated by the model and a real data output (e.g., training the model).

In some cases, the training is performed using a graphics card and via the Python programming language and/or via an X Processing Unit (XPU), where X may represent “G” as in graphics, “V” as in vision, “T” as in tensor, and/or “C” as in central. In some cases, training the model may employ Python, C, C++, JavaScript, Java, Rust, or other programming languages. Once trained, the weights that minimize the overall loss (or maximize a reward) across all trials or tasks of the demonstration may define or represent the generative ML model 135.

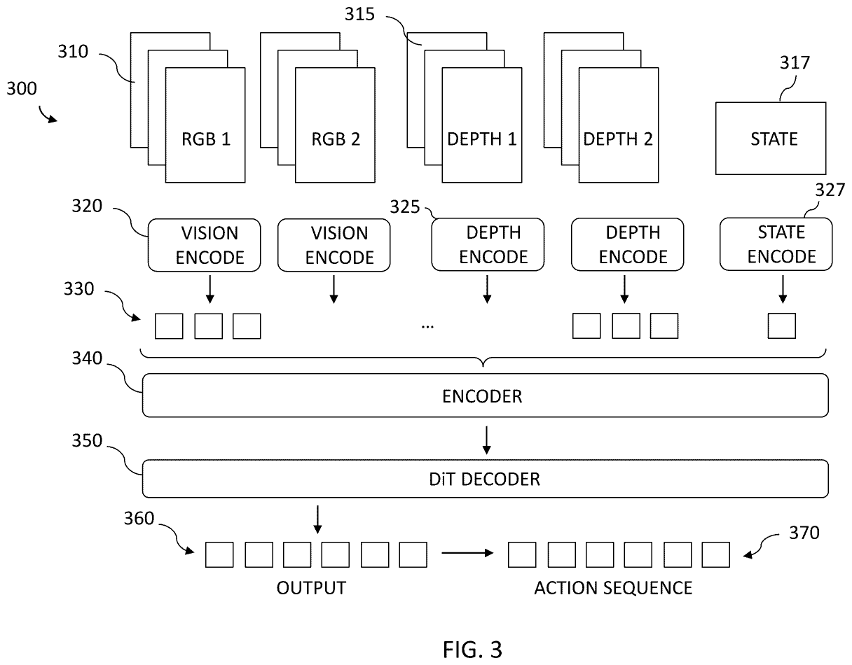

FIG. 3 is a diagram illustrating a network architecture 300 for implementing a machine learning generative model that controls material handling machines. As described herein, data, or observations, may be captured during a demonstration of a task. For example, the network architecture 300 may include captured data input as observations (RGB images, depth maps, robot state, and so on) at timestep t into a deep neural network, which outputs robot actions for timesteps t, t+d . . . , t+(N−1) d, where d and N may be arbitrary (e.g., d=50 ms, N=16).

The captured data may include RGB images 310, depth maps 315, state information 317 (e.g., from the movement data 215), other sensor data (e.g., weight, object or material descriptors, and so on), and so on.

Vision encoders 320 (e.g., vision transformers, or ViTs) encode the RGB images 310, depth encoders 325 (e.g., a lightweight multilayer perceptron (MLP) network) encodes the depth maps 315, and a state encoder 327 (e.g., a lightweight MLP network), encodes the state information (e.g., robot joints or EEF poses), into a set of encodings 330.

For example, the RGB images 310 are split into patches and processed through a ViT (e.g., a version of Dinov2 that utilizes registers, another ViT, a convolution neural network (CNN) network, such as ResNet/MobileNet, and so on). The depth maps 315 are also split into patches and processed using an MLP network (e.g., (any MLP and/or ViTs/CNNs). The state information 317 is encoded using a lightweight network composed of MLP, LayerNorm, and gaussian error linear units (GELU) layers.

The set of encodings 330 form a sequence of input tokens, <img_i, . . . , img_j, depth_i, . . . , depth_j, state>. In some cases, the set of encodings 330 may be based on a history of observations (e.g., multiple previous observations), and the token sequences of each timestep may be concatenated to form a single input sequence.

Next, one or more transformer encoders 340 and transformer decoders 350 generate actions to be executed by a machine. For example, the input tokens are fed into a stack of transformer encoder layers (e.g., with or without any attention masking). The decoder transformer decoder layers utilize a diffusion transformer (DiT) architecture, such as by utilizing the output of the encoder 340 to condition each decoder layer of the decoder 350. In some cases, a non-DiT decoder may be employed and/or architectures that only use the encoder 340, only use the decoder 350, and/or utilize non-transformer layers (e.g., 1D CNNs).

The decoder 350 outputs a series of outputs 360. The outputs 360 may include velocity fields when using flow matching models (e.g., also referred to as vector fields), raw/normalized action sequences when using autoregressive models, predicted noise when using diffusion models, transport mappings, or other model-specific outputs. For example, the architecture 300 may utilize a flow matching objective (e.g., via an optimal transport probability path) and not directly output a sequence of actions, but a sequence of the outputs 360. The outputs 360 are integrated across a series of integration steps, starting with random noise, to generate the final action sequence 370, such as a sequence of actions (e.g., machine control instructions) to control a machine when performing a task. In some cases, the architecture 300 may utilize a diffusion objective, and output noise predictions instead of the outputs 360. Thus, the generative ML model 135 may include the action sequence 370, as described herein.

In some embodiments, such as when the generative ML model is represented by weights determined by maximizing a reward, the system 130 may train the generative ML model via a reinforcement learning approach. For example, the machine 115 (or a model controlling the machine) explores a range of actions and tunes itself based on a successful exploration of the actions (e.g., makes decisions to maximize a cumulative reward). Thus, the machine control system 130, during the learning phase, may utilize demonstration data, reinforcement learning data, or various combinations, as described herein, when training and/or tuning the generative ML model 135.

The generative ML model 135 is deployed to the machine 120, such as to a group or set of machines 120A-120C at a location 230 (e.g., a laundry facility performing sorting tasks for non-rigid materials). As described herein, the generative ML model 135 may be deployed directly to the machines (e.g., stored locally at the machines 120A-C) and/or deployed to a remote server (e.g., the remote server 150).

Once deployed, the machine control system 130 may capture additional or new image data and feed the newly captured image data to the deployed generative ML model 135. These additional or new images may include images of the machine (e.g., the machines 120A-C), images of the machine with respect to the non-rigid materials (e.g., static images or during movement of the machine), images of what the machine is seeing, and so on. The machine control system 130, in some cases, may also capture additional data, such as weight data, humidity data, force data (e.g., a clamping force applied by the manipulator), depth data, ultrasound data, and so on.

The generative ML Model 135, as described herein, may determine movement data, or movement control data (e.g., time series data for the manipulators and/or joints), using the new or additional image data or other measured information. The machine control system 130 translates the movement data into instructions for controlling the machine (e.g., robotics instructions for controlling one or more robotic arms when performing a task or a series of tasks). Following the instructions, the machine performs the task or tasks.

In some cases, a feedback loop or module monitors the operation of the machine and provides feedback information to the machine control system 130. For example, the feedback loop may operate on order of a second (e.g., based on properties of the generative ML model 135), in order to minimize or mitigate erroneous outputs (e.g., hallucinations). In some cases, the feedback loop or module may operate based on a state of the environment, where the machine runs a policy after repetition of a successful task or unsuccessful task.

Further, the machine control system 130 may capture performance data, such as image data and/or movement data, during performance of a task by the machine. The system 130 may provide the captured data to further train the generative ML model 135 and/or refine or calibrate the model to the specific machine or operating environment within which the machine is working. For example, the machine may perform a number of tasks over time, causing wear and tear and/or slight modifications to its operating parameters or characteristics. The system 130, therefore, may utilize feedback and/or performance data to tune or further refine the generative ML model 135 to control the machine in its current use or operation, among other benefits.

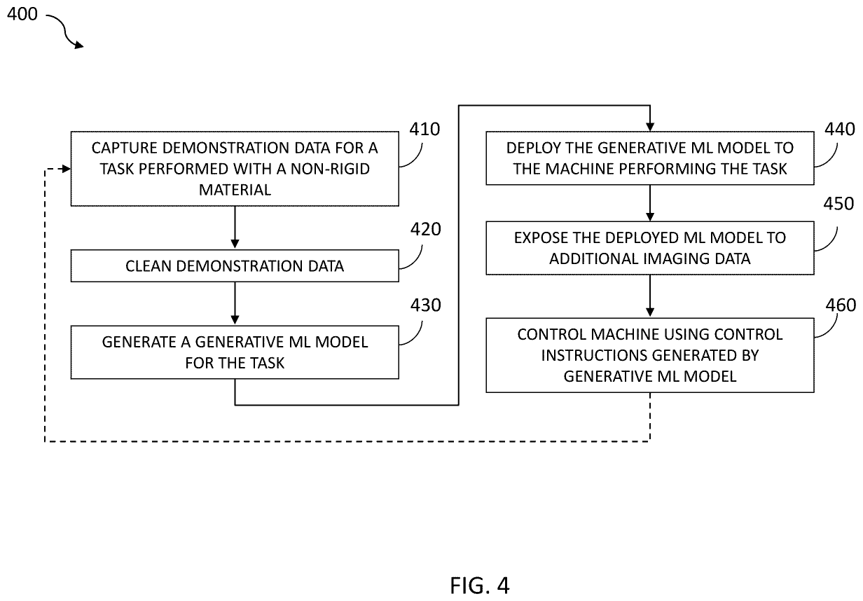

FIG. 4 is a flow diagram illustrating operations 400 performed by the machine control system 130. As described herein, the operations 400 may be grouped into two phases, a learning phase and an inference phase. As described herein, during the learning phase, a human may demonstrate how to perform a task (e.g., how non-rigid materials are to be manipulated), and the machine control system 130, in step 410, captures data related to the demonstration.

In some cases, the data may be captured from a simulated environment and/or a real environment (e.g., an environment that includes a human demonstration). For example, the simulated environment (e.g., a simulation of a task or operation) may be fully simulated and/or may be partially simulated (e.g., a portion of tasks are simulated).

In step 420, the system 130 optionally cleans the captured data, such as by removing data associated with erroneous or suboptimal actions within the demonstration. For example, the system 130 may filter for certain actions, movements, and/or behaviors performed by a robotic arm of the leader module 260, and remove data associated with those actions or behaviors (e.g., a multiple grab action, an empty grab action, a suboptimal path or starting position, and so on).

In some cases, the system 130 may clean the data by categorizing and/or tagging data sets based on its usefulness. For example, the system 130 may tag or label data sets as useful (e.g., use all of the data when training the model), not useful (e.g., ignore the data when training the model), or somewhat useful (e.g., possibly use the data for certain training aspects).

In step 430, the system 130 trains (or otherwise generates) the generative ML model. For example, the system 130 trains a generative ML model (e.g., the generative ML model 135) to learn how to perform the task (e.g., the actions to take to manipulate the non-rigid materials) using the captured data and/or data associated with the demonstration (e.g., real and/or simulated).

During the inference phase, the machine control system 135, in step 440, deploys the generative ML model 135 to a machine configured to perform a task (e.g., perform a sequence of operations associated with a non-rigid material). In step 450, the system 130 exposes the deployed ML model to new or additional imaging data, and the model determines control instructions (e.g., movement data or robotics data).

In step 460, the system 130 controls the machine using the determined or generated machine control instructions. For example, a machine policy or robot policy may receive robotic data (e.g., 3D coordinates for joint angles, rotation data and/or EEF pose data for a manipulator, and so on).

Thus, the machine control system 130 can train, create, generate, update, and/or modify the generative ML model to output control instructions for various types of machines, including machines that include or perform tasks using a manipulator at the end of a robotic arm. The machine may be of various sizes in order to accommodate the handling of different types or sizes of materials or objects. For example, the manipulator may be sized to handle large objects or small objects (e.g., the manipulator may have an open size of 5 mm to 70 mm and fingers having a width of 5 mm to 10 mm). Thus, the machine, being controlled by an ML model adapted for the parameters or dimensions of the machine, may enable a grasp fidelity, force, and/or friction during the performance of different tasks (e.g., manipulation of non-rigid materials).

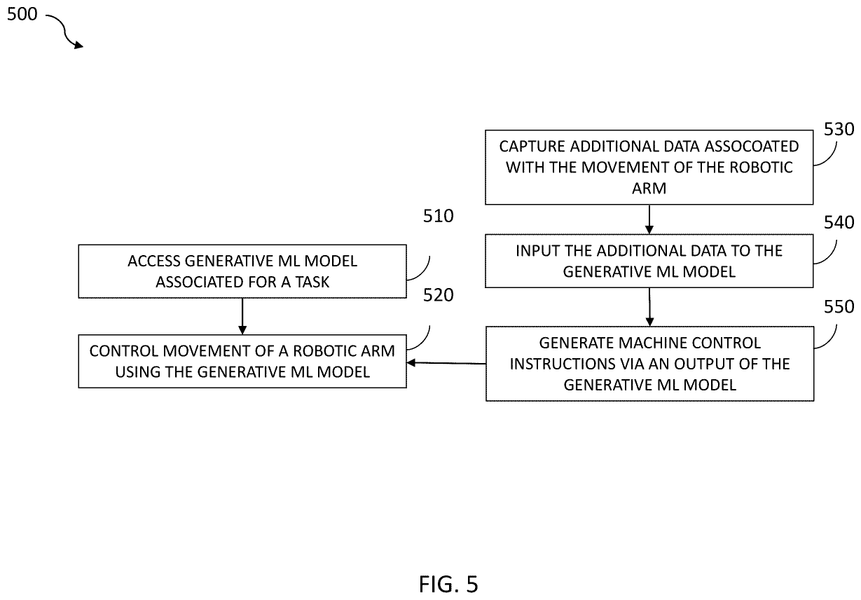

As described herein, in some embodiments, the machine control system 130 performs various methods or processes when controlling machines to perform tasks, such as tasks with non-rigid materials. FIG. 5 is a flow diagram illustrating a method 500 for controlling a material handling machine. The method 500 may be performed by the machine control system 130 and, accordingly, is described herein merely by way of reference thereto. It will be appreciated that the method 500 may be performed on any suitable hardware.

In operation 510, the machine control system 130 accesses a generative ML model. For example, the system 130 accesses and/or deploys the generative ML model 135 to a machine having a robotic arm, such as the machine 115. The system 130 may train the generative ML model 135 by capturing image data of a human performing a task associated with manipulating a non-rigid material, capturing movement data of the robotic arm of the machine mimicking performance of the task, and generating the generative ML model using the captured image data and the captured movement data.

In operation 520, the machine control system 130 controls movement of the robotic arm using the generative ML model. For example, the system 130 may control the robotic arm to perform one or more tasks associated with manipulating non-rigid materials, such as sorting, folding, singulating, lifting, dropping, stacking, feeding (e.g., into a machine), inserting (e.g., into a jig), and/or otherwise handling the non-rigid materials.

As described herein, the system 130, via the method 500, may perform one or more steps of the inference phase. For example, in operation 530, the system 130 may capture additional data associated with the controlled movement of the robotic arm, input, in operation 450, the captured additional data to the deployed generative ML model, and generate, in operation 500, machine control instructions via an output of the deployed generative ML model. The system 130, back to operation 520, may control the movement of the robotic arm via the generated machine control instructions.

The systems and methods described herein support the automatic control of machines to perform tasks associated with various objects, such as non-rigid materials that are flexible and/or deformable. Thus, the systems and methods facilitate the performance of the tasks by deploying ML models to the machines (e.g., without any explicit programming of the tasks to be performed).

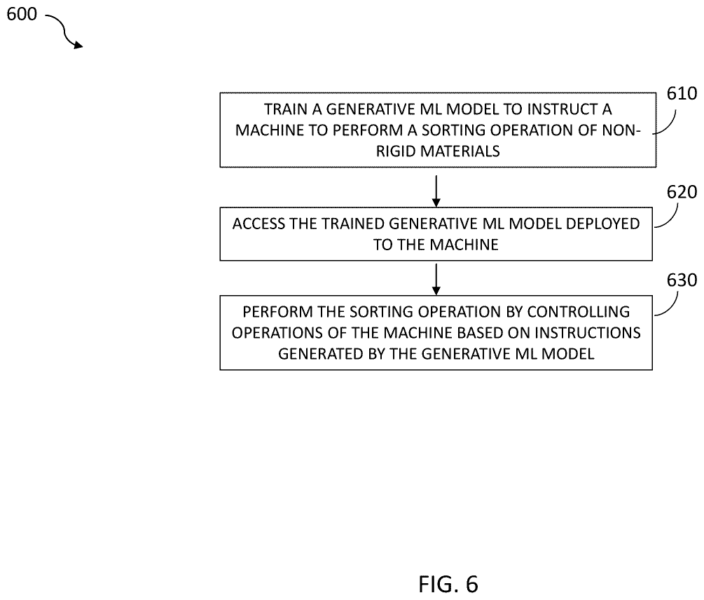

For example, FIG. 6 is a flow diagram illustrating a method 600 for sorting non-rigid materials using a machine controlled by a machine learning model. The method 600 may be performed by the machine control system 130 and, accordingly, is described herein merely by way of reference thereto. It will be appreciated that the method 600 may be performed on any suitable hardware.

In operation 610, the machine control system 130 trains a generative ML model to instruct a machine to perform a sorting operation of non-rigid materials. For example, the system 130 may capture data during a demonstration of the sorting operation and train the generative ML model 135 with the captured data.

In operation 620, the machine control system 130 accesses a generative ML model deployed to the machine, and, in operation 630, performs a sorting operation of two or more non-rigid materials by controlling operations of one or more robotic arms of the machine based on instructions generated by the generative ML model.

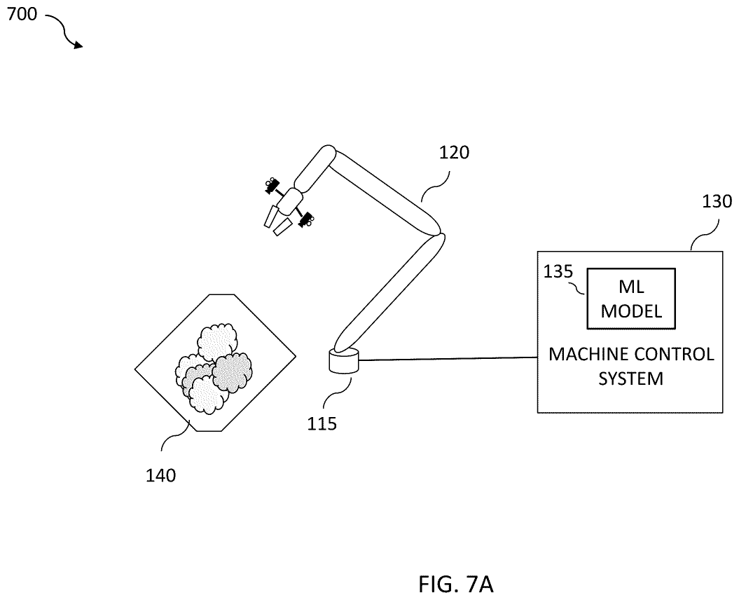

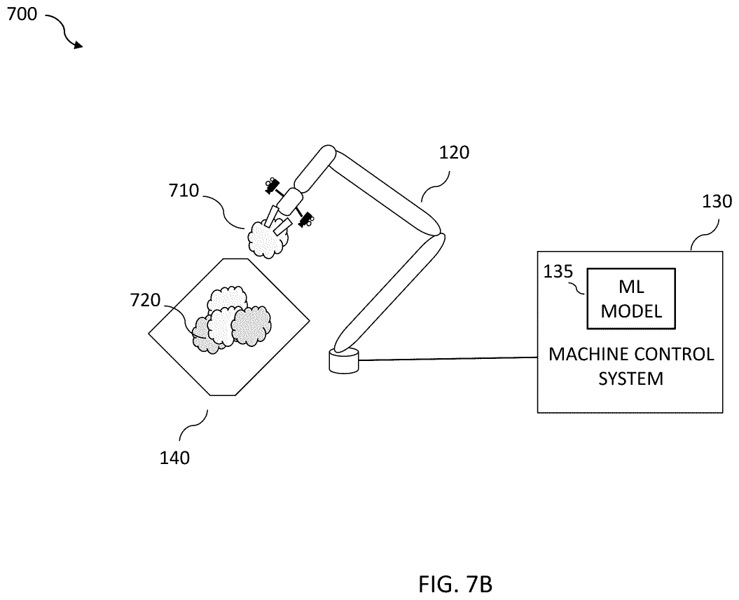

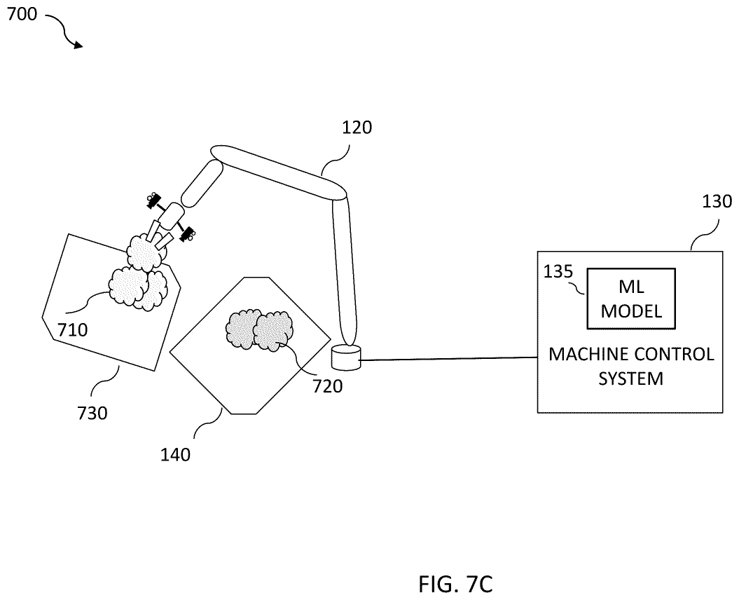

FIGS. 7A-7C are diagrams depicting the operation 700 of a machine sorting non-rigid materials. As shown in FIG. 7A, a machine control system 130, via the deployed generative ML model 135, controls the robotic arm 120 of the machine 115 when sorting the pile 140 of disparate non-rigid materials (e.g., napkins of two different colors).

FIG. 7B depicts a step in the sorting operation, such as movement of the robotic arm 120 to pick up a first object 710 in the pile 140 of the non-rigid materials, where the pile 140 includes non-rigid materials of different colors. The first object 710, for example, may be a white napkin. The pile 710 may include multiple white napkins and brown napkins (e.g., second objects 720).

FIG. 7C depicts a next step in the sorting operation, where the robotic arm 120 moves to place the first object 710 into a new pile 730 of the first objects 710. Thus, the robotic arm operates to sort the pile 140 of different colored napkins into piles of the napkins sorted by color.

Of course, as described herein, the robotic arm 120 (or multiple arms) may be controlled by the systems and methods described herein to perform other operations or tasks. For example, the systems and methods may deploy generative ML models to control machines to perform other non-rigid material manipulation tasks, such as folding, singulating, laying flat, stacking, removing, lifting, shaking, and so on.

As another example, the systems and methods may enable machines to perform operations or tasks associated with both non-rigid and rigid materials. For example, the machine may be performing a sorting operation of cloth napkins, and encounter forks or other metal cutlery (e.g., rigid objects) in a pile of napkins to be sorted. Based on the systems and methods described herein, the machine can identify the forks as rigid objects (e.g., not a target object for sorting) and perform actions to remove the forks during the operation.

Thus, in addition to the non-rigid materials described herein, the systems and methods may be implemented to perform operations or tasks associated with assembly operations (e.g., automobiles and vehicles, consumer electronics, automated drone assembly, and so on), construction (e.g., prefab homes, onsite drywall sanding, painting, and so on) machine tending (e.g., welding, soldering, deburring, surface treatments, surface deposition, and so on), quality assurance and/or quality control, or QA/QC (e.g., verifying the buttons on a refrigerator works), munitions manufacturing (e.g., machine tending, handling dangerous items, manual sorting of incendiary pellets, and so on), and others.

In some embodiments, the machine, during performance of a task or operation, may perform an action to capture additional information at certain decision points, such as when an object is unknown to the machine and/or the machine cannot identify the object with a certain probability. The machine, based on instructions within a deployed ML model, can perform an action to disambiguate or identify the object. For example, the machine may hold up the object and utilize weight sensor or image sensor information to identify the object, may read barcode or RFID tags attached to the objects, may read or identify an object based on other surface markings or distinguishable features, and so on.

### Example Embodiments of the Technology

As described herein, the systems and methods facilitate the deployment of generative ML models to machines that perform tasks associated with non-rigid materials and/or other materials. The systems and methods may be implemented as the following example embodiments.

In some embodiments, a method performed by a machine having a robotic arm includes accessing, via a control system of the machine, a generative ML model and controlling movement of the robotic arm using the generative ML model.

In some cases, the method includes capturing image data of a human performing a task associated with manipulating a non-rigid material, capturing movement data of the robotic arm of the machine mimicking performance of the task, and training the generative ML model using the captured image data and the captured movement data.

In some cases, the task includes sorting multiple different non-rigid materials using the robotic arm.

In some cases, the machine includes two robotic arms, and wherein the task includes folding the non-rigid material using the two robotic arms.

In some cases, the method includes capturing additional data associated with the controlled movement of the robotic arm, inputting the captured additional data to the deployed generative ML model, generating machine control instructions via an output of the deployed generative ML model, and controlling the movement of the robotic arm via the generated machine control instructions.

In some cases, the captured additional data includes images captured of the robotic arm of the machine performing the task.

In some cases, the captured additional data includes images captured of the robotic arm of the machine performing the task and depth information associated with positions of the robotic arm with respect to the non-rigid material.

In some cases, the captured additional data includes images captured of the robotic arm of the machine performing the task, depth information associated with positions of the robotic arm with respect to the non-rigid material, and information associated with the non-rigid material.

In some cases, the output of the deployed generative ML model includes time series data associated with movement of the robotic arm.

In some embodiments, a system includes a data collection module that captures data associated with a demonstration of a task to be performed by a machine having one or more robotic arms, a model generation module that trains an ML model based on the captured data, and a machine control module that controls operation of the machine using the ML model.

In some cases, the data captured by the data collection module includes image data of a human performing the task, wherein the task includes manipulating a non-rigid material, movement data of the one or more robotic arms of the machine during performance of the task, and depth data that identifies positions of the one or more robotic arms with respect to an object during performance of the task.

In some cases, the movement data includes data associated with movement of joints of the one or more robotic arms and data associated with operation of manipulators of the one or more robotic arms.

In some cases, the movement data includes end effect position quarternion information and end effector velocity quaternion information for manipulators of the one or more robotic arms.

In some cases, the depth data identifies the positions of the one or more robotic arms with respect to points on a three-dimensional representation of the object.

In some cases, the task includes a sorting operation of multiple different non-rigid materials.

In some cases, the task includes a folding operation of a non-rigid material.

In some cases, the task includes a removal operation of a first material from a group of second, different, materials.

In some cases, the generative ML model is a diffusion generative ML model.

In some cases, the machine control module performs an inference operation, by capturing additional data associated with the performance of the task, wherein the captured additional data includes images captured of the one or more robotic arms of the machine performing the task, and depth information associated with positions of the one or more robotic arms while performing the task, inputting the captured additional data to the generated ML model, generating machine control instructions via an output of the generated ML model, and controlling operation of the machine using the machine control instructions.

In some embodiments, a non-transitory, computer-readable medium whose contents, when executed by a control system of a machine, cause the machine to perform a method, including accessing a generative ML model deployed to the machine and performing a sorting operation of two or more non-rigid materials by controlling operations of one or more robotic arms of the machine based on instructions generated by the generative ML model.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A method performed by a machine having a robotic arm, the method comprising:
accessing, via a control system of the machine, a generative machine learning (ML) model; and
controlling movement of the robotic arm using the generative ML model.

2. The method of claim 1, further comprising:
capturing image data of a human performing a task associated with manipulating a non-rigid material;
capturing movement data of the robotic arm of the machine mimicking performance of the task; and
training the generative ML model using the captured image data and the captured movement data.

3. The method of claim 2, wherein the task includes sorting multiple different non-rigid materials using the robotic arm.

4. The method of claim 2, wherein the machine includes two robotic arms, and wherein the task includes folding the non-rigid material using the two robotic arms.

5. The method of claim 2, further comprising:
capturing additional data associated with the controlled movement of the robotic arm;
inputting the captured additional data to the deployed generative ML model;
generating machine control instructions via an output of the deployed generative ML model; and
controlling the movement of the robotic arm via the generated machine control instructions.

6. The method of claim 5, wherein the captured additional data includes images captured of the robotic arm of the machine performing the task.

7. The method of claim 5, wherein the captured additional data includes:
images captured of the robotic arm of the machine performing the task; and
depth information associated with positions of the robotic arm with respect to the non-rigid material.

8. The method of claim 5, wherein the captured additional data includes:
images captured of the robotic arm of the machine performing the task;
depth information associated with positions of the robotic arm with respect to the non-rigid material; and
information associated with the non-rigid material.

9. The method of claim 5, wherein the output of the deployed generative ML model includes time series data associated with movement of the robotic arm.

10. A system, comprising:
a data collection module that captures data associated with a demonstration of a task to be performed by a machine having one or more robotic arms;
a model generation module that trains a machine learning (ML) model based on the captured data; and
a machine control module that controls operation of the machine using the ML model.

11. The system of claim 10, wherein the data captured by the data collection module includes:
image data of a human performing the task,
wherein the task includes manipulating a non-rigid material;
movement data of the one or more robotic arms of the machine during performance of the task; and
depth data that identifies positions of the one or more robotic arms with respect to an object during performance of the task.

12. The system of claim 11, wherein the movement data includes:
data associated with movement of joints of the one or more robotic arms; and
data associated with operation of manipulators of the one or more robotic arms.

13. The system of claim 11, wherein the movement data includes end effect position quarternion information and end effector velocity quaternion information for manipulators of the one or more robotic arms.

14. The system of claim 11, wherein the depth data that identifies the positions of the one or more robotic arms with respect to points on a three-dimensional representation of the object.

15. The system of claim 10, wherein the task includes a sorting operation of multiple different non-rigid materials.

16. The system of claim 10, wherein the task includes a folding operation of a non-rigid material.

17. The system of claim 10, wherein the task includes a removal operation of a first material from a group of second, different, materials.

18. The system of claim 10, wherein the generated ML model is a diffusion generative ML model or flow matching generative ML model.

19. The system of claim 10, wherein the machine control module performs an inference operation, by:
capturing additional data associated with the performance of the task,
wherein the captured additional data includes:
images captured of the one or more robotic arms of the machine performing the task, and
depth information associated with positions of the one or more robotic arms while performing the task;
inputting the captured additional data to the generated ML model;
generating machine control instructions via an output of the generated ML model; and
controlling operation of the machine using the machine control instructions.

20. A non-transitory, computer-readable medium whose contents, when executed by a control system of a machine, cause the machine to perform a method, the method comprising:
accessing a generative machine learning (ML) model deployed to the machine; and
performing a sorting operation of two or more non-rigid materials by controlling operations of one or more robotic arms of the machine based on instructions generated by the generative ML model.
